(19) United States
(12) Patent Application Publication
(10) Pub. No.: US 2021/0334513 A1
(43) Pub. Date: Oct. 28, 2021

(54) A METHOD FOR DISTINGUISHING BETWEEN MORE THAN ONE FLUORESCENT SPECIES PRESENT IN A SAMPLE

(71) Applicant: ROYAL MELBOURNE INSTITUTE OF TECHNOLOGY, Melbourne, Victoria (AU)

(72) Inventor: Antony Orth, Collingwood (AU)

(21) Appl. No.: 16/322,742

(22) PCT Filed: Aug. 3, 2017
(86) PCT No.: PCT/AU2017/050816

§ 371 Date: Feb. 1, 2019

(30) Foreign Application Priority Data
Aug. 3, 2016 (AU) 2016903051

(51) Int. Cl. G06K 9/00; G06K 9/68; G06K 9/46; G01N 21/64; G02B 21/16; G02B 21/36

(52) U.S. Cl. CPC G06K 9/00147; G06K 9/6878; G06K 9/4652; G06K 9/0014; G06K 2009/4657; G01N 21/6408; G02B 21/16; G02B 21/365; G01N 21/6458

(57) ABSTRACT

Methods and systems are provided for distinguishing between more than one fluorescent species present in a sample in fluorescence microscopy. The method involves illuminating the sample with at least one light source. More than two images of the illuminated sample are recorded over a period of time, each image comprising a plurality of pixels, wherein each pixel corresponds to a location in the sample and records a degree of fluorescence at the location in the sample at a particular point in time. A photostability characteristic of the degree of fluorescence at each pixel over the period of time over which the more than two images were recorded is determined and used to distinguish between the more than one fluorescent species present in the sample.

### PRIORITY CLAIM

This application is a national stage application of PCT/AU2017/050816, filed on Aug. 3, 2017, which claims the benefit of and priority to Australian Patent Application No. 2016903051, filed on Aug. 3, 2016, the entire contents of which are each incorporated by reference herein.

### TECHNICAL FIELD

The present disclosure relates broadly to methods and systems for distinguishing between more than one fluorescent species present in a fluorescence microscopy sample. More particularly, the disclosure relates to novel methods which may be used to enhance multiplexing capability of methods for distinguishing fluorescent species based on their spectral emissions or can be used independently thereof.

### BACKGROUND

Fluorescence microscopy is widely used in biological and clinical research for high contrast imaging. Fluorescence microscopy enables the study of properties of organic and inorganic substances using fluorescence instead of, or in addition to reflection and absorption properties. Fluorescent molecules known as fluorophores will emit a particular colour of light when illuminated with a light source. The colour of light emitted by a particular fluorophore is dependent on the chemical structure of the fluorescent molecule. Different species of fluorophores are comprised of different combinations of aromatic groups, or plane or cyclic molecules with several covalent bonds. The colour of light emitted by a fluorophore upon excitation is significant because it can be used to distinguish between different fluorescent species.

In fluorescence microscopy, typically two to three types of cellular structures or proteins are each labelled using a fluorescent species having a distinct spectral emission. Combinations of different light or excitation sources together with excitation filters are employed together with various spectral emission filters to provide spectral contrast between the particular fluorescent species used to label structures or proteins in a particular experiment. Each excitation and emission filter will only transmit light of a certain colour. This enables fluorescent species which emit or absorb light of a particular colour to be distinguished. The ultimate objective of quantitative fluorescence microscopy is to provide a relative measure of the concentration or abundance of a designated or given fluorescent species at a designated or given spatial location, thereby identifying particular cellular structures or proteins in the sample.

In practice, since fluorophores emit over a finite bandwidth when excited, inevitable mixing between fluorescent channels will occur. That is, fluorescent emissions from a particular fluorescent species may contribute to the signal recorded in multiple emission channels. This phenomena referred to as spectral “bleed-through” can be significant when using more than three fluorescent species, requiring the application of unmixing algorithms to distinguish between the fluorescent species. Generally, spectral unmixing procedures are effective, however it is not possible to distinguish more fluorescent species than the number of available spectral channels.

Certain known spectral excitation and emission filter based fluorescence microscopes have at most, four excitation/emission filter combinations and are therefore equipped to spectrally separate a maximum of four fluorescent species. Achieving more than four spectral is challenging since a clear separation of fluorophore signals typically requires the respective emission filters to be separated by more than 60 nm in wavelength.

The visible colour spectrum is roughly 300 nm wide, from 400 to 700 nm. Each fluorescent species emits over roughly 30 to 40 nm. See for example, FIG. 1 which shows a series of spectral windows in fluorescence microscopy. In this example, the excitation (shown by the dotted lines) and emission (shown by the solid lines) is displayed for a typical combination of four fluorescent species. The associated excitation and emission filters are overlaid as rectangles of different shading. Fluorescent species that emit similarly coloured light will overlap spectrally, i.e. the emission profile is said to be “mixed”. In this case, mathematical analysis or unmixing is required to separate the contribution from each fluorescent species to the overall emission profile.

A significant library of fluorescent markers and proteins is available for use. However, certain fluorescent species are suited to certain targets, and many laboratories develop protocols for working with some families of fluorophores and not others. For example, DAPI is commonly used to highlight cell nuclei and is not considered appropriate for highlighting other cellular structures. Accordingly, the DAPI emission spectrum (typically observed from 400 to 460 nm) is typically reserved for nucleus staining. As a result, limitations relating to the selection of fluorescent species which emit in a designated or given colour region can restrict the total number of fluorophore types that can be used in an experiment.

In light of the foregoing issues, there is a practical upper limit to the total number of fluorescent species that can be used to mark structures and/or proteins in any given experiment. Accordingly, it would be desirable to provide another parameter for distinguishing between fluorescent species.

### SUMMARY

According to an aspect of the present disclosure, there is provided a method for distinguishing between more than one fluorescent species present in a sample in fluorescence microscopy, the method including the following steps: illuminating the sample with at least one light source; recording more than two images of the illuminated sample over a period of time, each image comprising a plurality of pixels, wherein each pixel corresponds to a location in the sample and records a degree of fluorescence at the location in the sample at a particular point in time; and determining a photostability characteristic of the degree of fluorescence at each pixel over the period of time over which the more than two images were recorded; wherein the photostability characteristic of the degree of fluorescence at each pixel is used to distinguish between the more than one fluorescent species present in the sample.

That is, the method provided by the disclosure in accordance with various embodiments enables discrimination of fluorescent species based on a photostability characteristic which may relate to either a decrease or decay in photo intensity, i.e. a photostability characteristic, and/or a photo recovery characteristic, i.e. based on an increase in photo intensity.

Using the photostability characteristic of the degree of fluorescence at each pixel to distinguish between the more than one fluorescent species present in the sample may further include determining a photostability characteristic of the degree of fluorescence for each fluorescent species present in the sample.

The more than one fluorescent species present in the sample may be at least three fluorescent species. Five fluorescent species can be readily distinguished using the method of the present disclosure as demonstrated by way of various examples which are not intended to be regarded as limiting.

In certain embodiments, using the photostability characteristic of the degree of fluorescence to distinguish between the more than one fluorescent species present in the sample further includes determining an abundance of each fluorescent species present in the sample.

The abundance of each fluorescent species present at each pixel over the period of time over which the more than two images were recorded may be determined by applying an unmixing algorithm.

The unmixing algorithm may be a singular value decomposition (SVD) or a non-negative least squares algorithm (NNLS).

The photostability characteristic of the degree of fluorescence at each pixel over the period of time over which the more than two images were recorded may be determined by applying an unmixing algorithm.

The unmixing algorithm may be a non-negative matrix factorisation algorithm (NMF). In some embodiments, the unmixing algorithm is a non-increasing non-negative matrix factorisation algorithm (NI-NMF).

In certain embodiments, the sample is illuminated with radiation of a particular wavelength.

In another embodiment, the sample is illuminated by more than one light source, each light source being configured to emit radiation at a particular wavelength.

In certain embodiments, the method further includes the following steps: illuminating the sample with at least one light source; applying at least one spectral filter on an emission or excitation side of the sample; recording one image of the illuminated sample for each spectral filter, each image comprising a plurality of pixels, wherein each pixel corresponds to a location within the sample and records a degree of fluorescence at the location in the sample; and determining a degree of fluorescence at each pixel for within two or more spectral bands; wherein the degree of fluorescence at each pixel within the two or more spectral bands is used to distinguish between the more than one fluorescent species present in the sample. That is, by using two parameters to distinguish between fluorescent species, i.e. the photostability characteristic of the degree of fluorescence and the degree of fluorescence, higher fidelity results are achievable.

In one particular embodiment, two or more spectral filters are applied on the emission side of the sample, and each of the two or more spectral bands is associated with one of the two or more spectral filters.

In another embodiment, more than one light source is used to illuminate the sample and a single spectral filter is applied on the emission side of the sample, such that the two or more spectral bands are acquired by varying the light source.

According to another embodiment, there is provided a system configured to distinguish between more than one fluorescent species present in a sample in fluorescence microscopy, the system including: at least one light source configured to illuminate the sample; an image recording device configured to record more than two images of the illuminated sample over a period of time, each of the more than two images comprising a plurality of pixels, wherein each pixel corresponds to a location in the sample and records a degree of fluorescence at the location in the sample at a particular point in time; a processor configured to determine a photostability characteristic of the degree of fluorescence at each pixel over the period of time over which the more than two images were recorded; and a display configured to present to a user the relative abundance of each fluorescent species in the sample at each pixel based on the photostability characteristic of the degree of fluorescence at each pixel.

The processor may determine a photostability characteristic of the degree of fluorescence for each fluorescent species present in the sample prior to determining the photostability characteristic of the degree of fluorescence at each pixel over the period of time over which the more than two images were recorded as an indicator of the relative abundance of each fluorescent species in the sample at each pixel.

The processor may apply an unmixing algorithm to determine the relative abundance of more than one fluorescent species at each pixel.

The unmixing algorithm may be singular value decomposition (SVD) or a non-negative least squares algorithm (NNLS).

The processor may apply an unmixing algorithm to determine the photostability characteristic of the degree of fluorescence at each pixel over the period of time over which more than two images were recorded.

The unmixing algorithm may be a non-negative matrix factorisation (NMF). In some embodiments, the unmixing algorithm may be a non-increasing non-negative matrix factorisation (NI-NMF).

In certain embodiments, each light source is configured to emit radiation at a particular wavelength.

According to another embodiment, there is provided computer program code for configuring a processor to implement a method for distinguishing between more than one fluorescent species present in a sample in fluorescence microscopy, the processor being configured to: cause the sample to be illuminated with at least one light source; record more than two images of the illuminated sample over a period of time, each image comprising a plurality of pixels, wherein each pixel corresponds to a location in the sample and records a degree of fluorescence at the location in the sample at a particular point in time; and determine a photostability characteristic of the degree of fluorescence at each pixel over the period of time over which the more than two images were recorded; and generate a relative abundance map for each fluorescent species in the sample at each pixel based on the photostability characteristic of the degree of fluorescence at each pixel for display to a user.

Additional features are described in, and will be apparent from the following Detailed Description and the figures.

### BRIEF DESCRIPTION OF DRAWINGS

It will be convenient to hereinafter describe the disclosure in greater detail by reference to the accompanying figures which facilitate understanding of the method according to this disclosure. The particularity of the figures and the related description is not to be understood as superseding the generality of the broad identification of the disclosure as given in the attached claims.

FIG. 1 shows the results of a spectral emission analysis using a fluorescence microscope according to conventional methods.

FIG. 2 is a flowchart providing an overview of the method for distinguishing between more than one fluorescent species present in a sample in fluorescence microscopy according to an embodiment of the disclosure.

FIG. 3A shows the green spectral channel of a dual spectral channel fluorescent microscope image of a sample including five fluorescent species, with examples of beads representing different fluorescent species boxed and labelled as I to V.

FIG. 3B shows the red spectral channel of the dual spectral channel fluorescent microscope image of FIG. 3A.

FIG. 3C shows a time trace or photo bleaching curve for beads I to V of FIGS. 3A and 3B during a photo bleaching experiment.

FIGS. 3D to 3H show corresponding unmixed images showing fluorescence isolated to bead types I to V.

FIG. 4A shows a single spectral channel fluorescent microscope image of a sample including two fluorescent species, with examples of beads representing different fluorescent species boxed and labelled as II and V.

FIG. 4B shows a time trace or photo bleaching curve for beads II and V of FIG. 4A during a photo bleaching experiment.

FIG. 4C shows an unmixed image highlighting the first of two different fluorescent species.

FIG. 4D shows an unmixed image highlighting the second of two different fluorescent species.

FIG. 5A shows a first frame of a greyscale time lapse image produced by summing two spectral channels of a fluorescence microscope image of cells from two mouse blastocysts.

FIG. 5B shows a time trace or photo bleaching curve of the mouse blastocysts of FIG. 5A labelled with DAPI (i.e. cell nuclei) and AlexaFluor 594 (i.e. the bulk of the blastocyst).

FIG. 5C shows the resulting abundance map for the cell nuclei labelled with DAPI.

FIG. 5D shows the resulting abundance map for the bulk of the blastocyst labelled with AlexFluor 594.

FIG. 6A shows a fluorescent microscope image of a mouse cumulus-oocyte-complex (COC) using a spectral emission filter in the 575-675 nm range.

FIG. 6B shows a time trace or photo bleaching curve corresponding the two autofluorescent species present in the sample shown in FIG. 6A.

FIG. 6C shows an unmixed image highlighting the first of two different fluorescent species.

FIG. 6D shows an unmixed image highlighting the second of two different fluorescent species.

FIG. 7A. shows a first frame of a greyscale time lapse image using 485 nm LED excitation to excite Alexa Fluor 555 (Ki67), Green Fluorescent Protein (GFP) expressing mitochondria and Alexa Fluor 430 (microtubules).

FIG. 7B shows the resulting abundance map for unmixed Alexa Fluor 430 (microtubule) using NI-NMF.

FIG. 7C shows the resulting abundance map for unmixed GFP (mitochondria) using NI-NMF.

FIG. 7D shows the resulting abundance map for unmixed Alexa Fluor 555 (Ki67) using NI-NMF.

FIG. 7E shows a photo bleaching curve for GFP, Alexa Fluor 555, and Alexa Fluor 430.

FIG. 8A shows the tenth frame of a reversible photo bleaching time lapse of GFP (Golgi) expressing CaCO₂ cells, stained with Alexa Fluor 488 (actin).

FIG. 8B shows the eleventh frame of a reversible photo bleaching time lapse of GFP (Golgi) expressing CaCO₂ cells, stained with Alexa Fluor 488 (actin). The sample is irradiated with 405 nm light between the tenth and eleventh frames to induce photo recovery of GFP.

FIG. 8C shows the twentieth frame of a reversible photo bleaching time lapse of GFP (Golgi) expressing CaCO₂ cells, stained with Alexa Fluor 488 (actin).

FIG. 8D shows a series of plots showing the photo intensity of the boxed regions in FIGS. 8A to C. The intensity trace of the central pixel located in the dotted square in FIG. 8B is shown in the dotted (solid) curve. Both curves are normalized so that their maximum value=1.

FIG. 8E shows the resulting abundance map for unmixed GFP using NMF on frames 10 (FIG. 8A) and 11 (FIG. 8B).

FIG. 8F shows the resulting abundance map for unmixed image of Alexa Fluor 488 using NMF on frames 10 (FIG. 8A) and 11 (FIG. 8B).

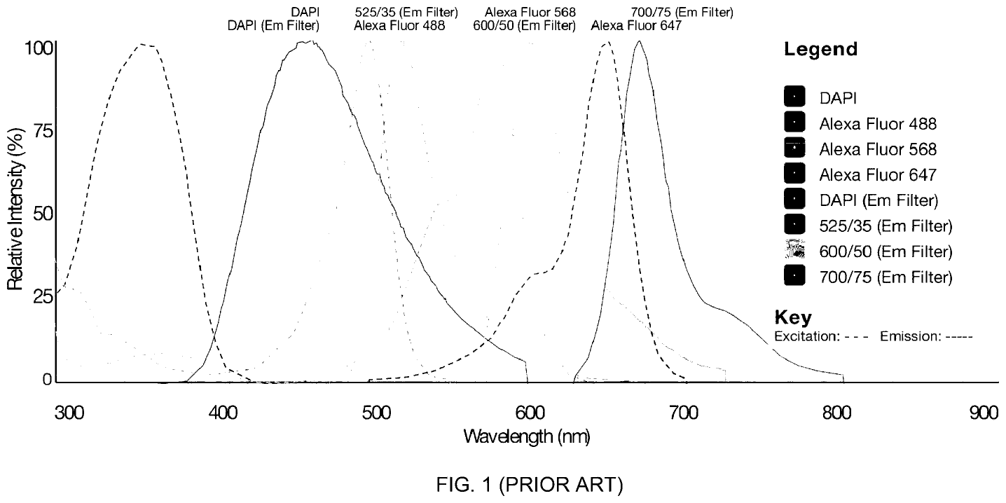

### DETAILED DESCRIPTION

Fluorescence photo bleaching is a phenomenon causing a decrease in the emission intensity of an illuminated fluorescent sample over time. The decrease in emission intensity is the result of chemical reactions between the excited fluorescent molecules and the surrounding medium. Photo bleached fluorophores are effectively irreversibly “switched off” and are no longer able to emit light. Theoretically, the emission intensity (I) of a group of fluorescent molecules decreases exponentially over time (t) according to I(t)=I(0)e^{-kt}. The bleaching constant k depends on various experimental and environmental parameters in addition to the structure of the fluorescent molecule itself. For example, the wavelength of the illuminating light source, excitation power, oxygen concentration, and the fluorescent molecule's energy level structure will all affect its bleaching rate. As a result, spectrally identical fluorophores can have different photo bleaching rates.

Photo bleaching is an unavoidable property of fluorophores which is commonly considered to be detrimental to experimental outcomes. However, in accordance with the method and system of the present disclosure, this unfavourable property of fluorophores is exploited to distinguish between different fluorescent species.

In conventional fluorescence microscopy, only a single fluorescent species can be separated for each spectral channel observed. Observation of photo bleaching or photo recovery characteristics in accordance with aspects of the present disclosure, provides an alternative avenue of distinguishing the fluorescent species present in a sample, or in some embodiments, provides an additional dimension of observation, making it possible to at least double the number of resolvable fluorescent species within a sample when compared with observation of spectral characteristics alone. The inventor has been able to triple the number of resolvable species using the method described herein. Moreover, observation of photo bleaching and/or photo recovery behaviour enables distinction between fluorophores having substantially identical emission spectra, which is impossible using spectral information alone.

Accordingly, the present disclosure provides a way for exploiting the photo bleaching, photo recovery or photo switching (i.e. reversible photo bleaching) behaviour of fluorescent species as an identifying characteristic, which may be used separately from or in combination with spectral signatures. The term “photostability characteristic” will therefore be understood to refer to either a decrease or decay in photo intensity, i.e. a photostability characteristic, and/or a photo recovery characteristic, i.e. based on an increase in photo intensity.

In embodiments where a decay or photo bleaching characteristic is used as the photostability characteristic, the technique is referred to as “bleaching-assisted multichannel microscopy” or BAMM. In embodiments where the photo recovery or photo switching characteristic is used as the distinguishing photostability characteristic, the technique is referred to as “reverse bleaching-assisted multichannel microscopy” or Reverse BAMM.

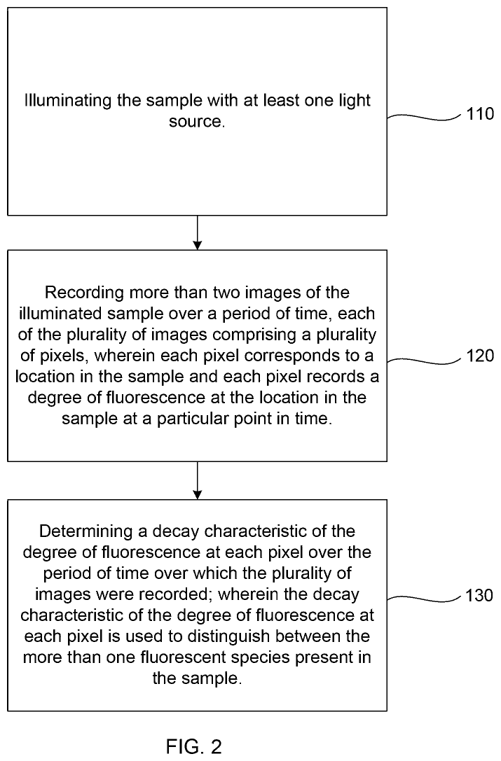

Referring firstly to FIG. 2, the method of the present disclosure provides an inventive way to distinguish between more than one fluorescent species present in a sample in fluorescence microscopy 100. At step 110, the fluorescence microscopy sample is illuminated with at least one light source. At step 120, images of the illuminated sample are recorded over a period of time, i.e. a time lapse recording of more than two images recorded during illumination of the sample, a number of say 20 to 50 frames may be considered suitable. Each image in the time lapse comprises a plurality of pixels at a point in time, and each pixel corresponds to a location in the sample, i.e. each pixel records a degree of fluorescence at that location in the sample at a particular point in time. Illumination of the sample over the period of time over which the images are recorded causes the degree of fluorescence emitted by the various fluorescent molecules in the sample to fade due to the phenomena referred to as “photo bleaching”. At step 130, a photostability characteristic of the degree of fluorescence is determined at each pixel over the period of time over which the time lapse images were recorded. The photostability characteristic determined at each pixel is used to distinguish different fluorescent species present in the sample.

Assuming that several fluorescent species are present in a sample, they will potentially collectively contribute to the signal collected at any given pixel. In principle, determining the relative abundance of each fluorescent species using photo bleaching can be achieved by fitting the amplitudes of a multi-exponential decay at each pixel. A wide range of computational approaches can be applied to this problem, including maximum likelihood estimation, the method of least-squares, the method of moments, the Gardner Transform, singular value decomposition (SVD), non-negative least squares algorithm (NNLS) or non-negative matrix factorisation (NNMF).

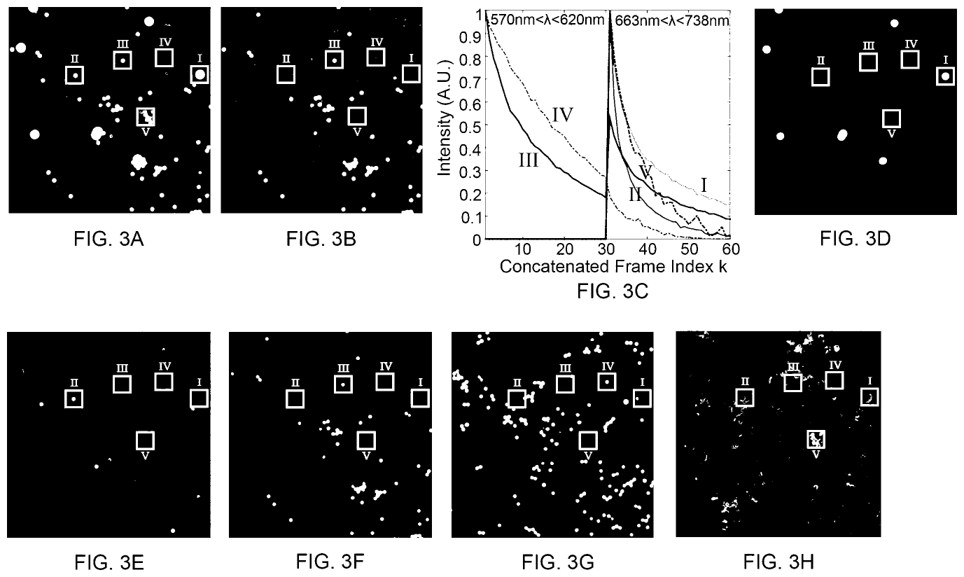

The photostability characteristic of the degree of fluorescence for each fluorescent species represented in the sample is extracted from the dataset sample itself either by a user assisted unmixing approach or via NMF. Example 1 demonstrates the user assisted approach, while the automated method using NMF is described in Examples 2 and 3. In the user assisted approached, the user has at least some knowledge about the composition of the sample and uses this knowledge to manually identify N=5 pixels as shown for example in FIG. 3A. Each of the N=5 pixels contains signal from one of the fluorescent species present in the sample. FIG. 3A and FIG. 3B show the green spectral channel and red spectral channel respectively of a fluorescence image containing five different types of beads which are boxed and labelled I to V. In FIG. 3C there is shown an exemplary 30-frame time lapse photo bleaching curve in each of two spectral emission channels, providing a total of 60 data points across spectral and temporal dimensions. Concatenated frames 1-30 indicate the bleaching behaviour of the emission within the green spectral channel (570 to 620 nm), and concatenated frames 31-60 indicate the bleaching behaviour of the emission within the red spectral channel (633 to 738 nm). Each curve therefore represents the combined spectral and photostability characteristics of a given type of bead. Figs. D to H are unmixed images showing fluorescence isolated to bead types I to V respectively. Accordingly, each of these unmixed images contains signal from only one type of bead.

The least-square solution to the following equation:

$$\vec{I} ( x , y ; z ) = {\sum }_{i = 1}^{N} {a}_{i} ( x , y ) {\vec{v}}_{i} ( k ) \qquad Equation ( 1 )$$

where \vec{I}(x, y; z) is the (measured) intensity at pixel (x, y) and at concatenated frame index k, aᵢ(x, y) 0 is the relative scalar abundance of fluorophore i at pixel (x, y) and \vec{v}ᵢ(k) is the 60-element spectral-bleaching fingerprint (i.e. a vector) for fluorophore type i. That is, the photostability characteristic of the degree of fluorescence for that particular fluorescent species. The non-negative prior for aᵢ prevents the unmixed abundances from reaching non-physical negative values and improves unmixing fidelity. Its implementation requires an iterative approach.

The constrained least-squares solution to Equation (1) above yields an N-channel image. The i^{th} image, i.e. the abundance map of fluorophore type i, is given by aᵢ(x, y) and contains only signal from the i^{th} fluorescent species. The image of FIG. 3D to H comprise five independent fluorophore abundance maps, each indicating the relative concentration of the given fluorescent species. In practice, abundance maps for bead types I to V are presented in colour so that different bead types can be shown in red, yellow, purple, green and blue, respectively.

Although the example illustrated in FIGS. 3A to 3H does not contain any spatially overlapping structures, the mathematical solution can handle this possibility. Using standard spectral unmixing techniques used in conventional fluorescence microscopy, it would only be possible to isolate M fluorescent species using N spectral channels. Using the method proposed by the present disclosure, this conventional approach can be improved by a factor of 2.5, i.e. unmixing five independent fluorophore abundance maps using just two spectral channels. In this case, the fluorophore contrast is yielded by observing both photo bleaching and spectral behaviour.

### Example 1

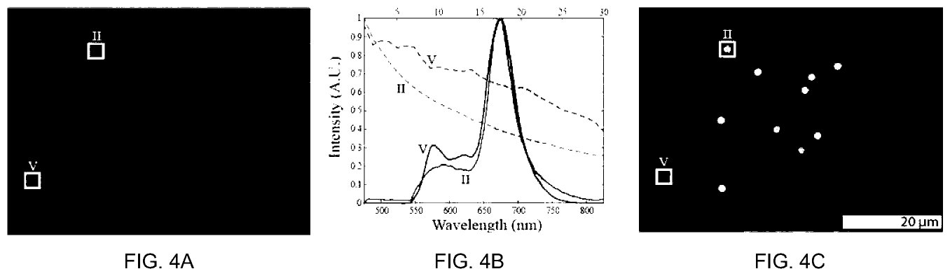

Referring now to FIGS. 4A to 4D, the method of distinguishing between more than one fluorescent species present in a sample was applied to a sample including a mixture of fluorescent molecules of species referred to as types II and V. The fluorescent molecules were dried on a slide and imaged on a confocal microscope, using a single spectral emission channel. FIG. 4A shows the first image in a 30-frame time lapse photo bleaching dataset obtained of the sample. Although the emission spectra of the two fluorescent species are very similar as shown in FIG. 4B (shown in solid lines), their photo bleaching stability differs sufficiently enough to allow unmixing using the method proposed by the present disclosure as shown in FIGS. 4C and 4D (as shown in dotted lines in FIG. 4B). In this example, unmixing the fluorescent species based on spectral data only would be impractical, if not impossible due to their substantially identical emission spectra. Using the method of the present disclosure, the two species of fluorescent molecules are readily separable as shown in FIGS. 4C and 4D.

### Example 2

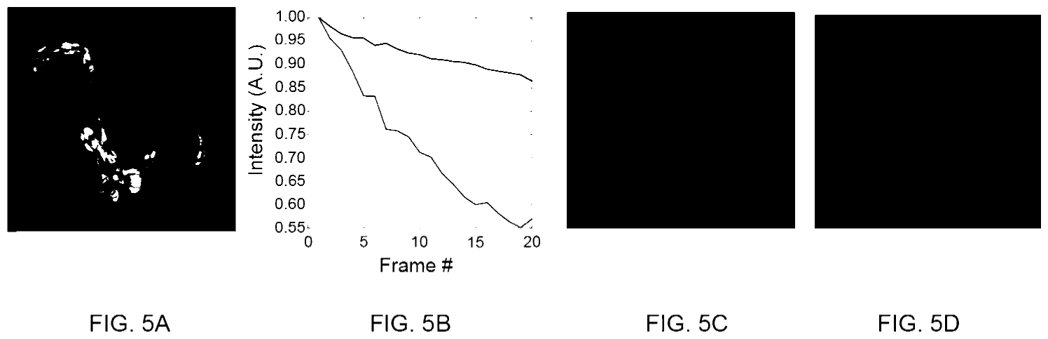

The proposed unmixing methods are also capable of separating spatially overlapping objects as are commonly encountered in biological samples. For example, imaging embryonic cells derived from mouse blastocysts labelled with DAPI (the cell nuclei) and AlexaFluor 594 (the bulk of the blastocyst). The signals from these two spectral emission channels were collected simultaneously by two detectors, and summed in MATLAB to produce a single channel 20-frame bleaching time lapse data set. The first frame of the monochromatic image series is shown in FIG. 5A. As in the example illustrated in FIGS. 4A to 4C, processing the image data starts with a single spectral channel. In general, overlapping structures preclude the possibility of finding pixels that contain each of the fluorescent molecules in isolation. Accordingly, it is not possible to use the earlier described manual and user assisted methods of identifying pixels containing a signal from just one of the fluorescent species present in the sample. Instead, an indirect technique is used to estimate the bleaching behaviour of each species. That is, a non-negative matrix factorization (NMF) algorithm (available in MATLAB) is used for simultaneous estimation of the bleaching behaviour of each fluorescent species present in the sample together with their spatial distribution, given a non-negativity constraint. FIG. 5B shows the resulting bleaching behaviours, i.e. DAPI photo bleaches more slowly than AlexaFluor 594.

Referring now to FIG. 5B, the contribution from each fluorescent species can be extracted from the single channel photo bleaching time lapse using matrix pseudo-inversion to provide the two curves. The resulting abundance maps are shown in FIGS. 5C and 5D. The cell nuclei are not duplicated in the AlexaFluor 594 channel shown in FIG. 5D. The spatial overlap between both fluorescent species is maintained.

Fluorophores are typically engineered to maximise photostability. However, many biomolecules are naturally fluorescent due to a phenomenon called auto fluorescence. In contrast to commercial dyes, such auto fluorescent molecules are not designed for photostability or multichannel imaging, and therefore will tend to have substantially overlapping spectral profiles and display a wide range of photo bleaching behaviours. The former makes them particularly hard to unmix, whilst the latter makes them suitable for identification using the method of the present disclosure.

### Example 3

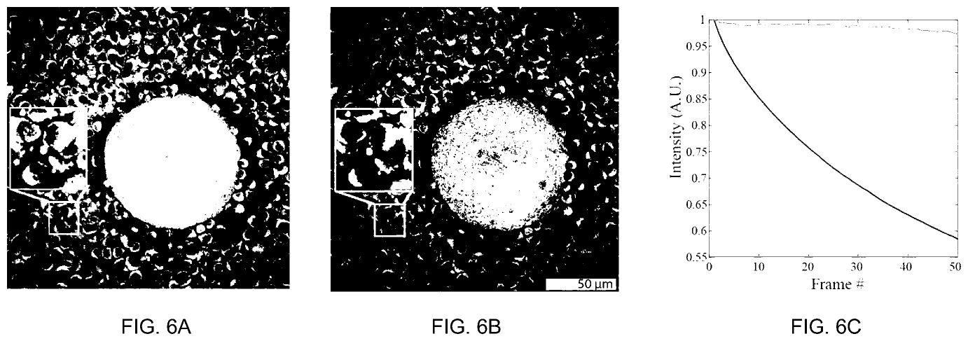

Referring now to FIG. 6A there is shown a mouse cumulus-oocyte-complex (COC) imaged using an emission filter within the wide yellow-to-red emission window (575-675 nm). A non-negative matrix factorization is used to estimate the photostability characteristic of fluorescence for two fluorescent species the resulting photo bleaching curves are shown in FIG. 6B. The corresponding unmixed images are shown in FIGS. 6C and 6D. Using photostability as a contrast method, a distribution of photo stable foci is resolved within the cumulus cells. In this example, no spectral data is used and the results are based purely on photo bleaching data.

### Example 4

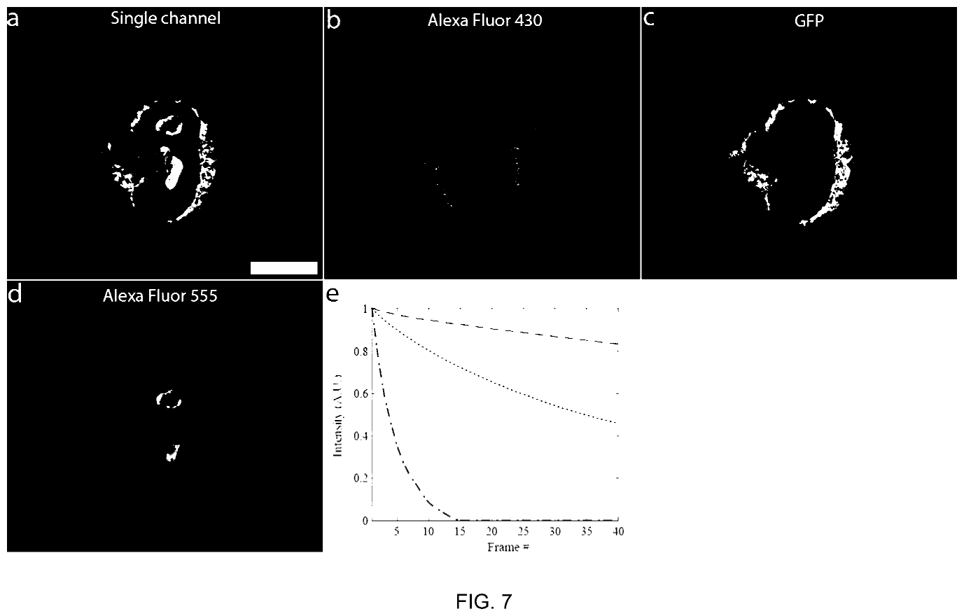

Referring now to FIGS. 7A to 7E, unmixing three types of fluorophores using photo bleaching as the photostability characteristic requires a priori information beyond non-negativity in order to reduce the solution space. The alternating least squares NMF algorithm is modified to force the solution to the bleaching curves to be monotonically non-increasing. This guarantees that the NMF solution is physically consistent with the knowledge that fluorescent intensity must decrease over time. This approach is referred to as the non-increasing NMF algorithm (NI-NMF). This restriction to monotonically decreasing basis functions (i.e., the bleaching trace estimates) is critical to enable three-component unmixing using BAMM. NI-NMF is a modification to the standard ALS NMF procedure. At each iteration, if the value of a bleaching trace estimate B(t) at time t=tₙ₊₁ exceeds the value of the bleaching trace estimate at time tₙ, then B (tₙ₊₁)=B (tₙ). This modification is successively performed for each time point so that the value of the bleaching trace is decreased monotonically. In the example illustrated in FIGS. 7A to 7E, NI-NMF is run for 25 replicates, and the result with the lowest mean-squared error is selected as the solution. FIG. 7A shows a HeLa cell with three fluorescent emitters, Alexa Fluor 555 (Ki67), Green Fluorescent Protein (GFP) and Alexa Fluor 430 (microtubules), in a single spectral channel using 485 nm LED excitation. The scale bar for FIG. 7A is 20 μm. FIGS. 7B to 7D show unmixed fluorophore abundance maps using NI-NMF BAMM. This unmixing result represents a three-fold increase in resolvable species over the traditional multiplexing limit using just one spectral channel. The associated estimated bleaching traces for GFP (dotted curve), Alexa Fluor 555 (dashed curve), and Alexa Fluor 430 (dot-dashed curved) are shown in FIG. 7E. The NI-NMF algorithm correctly returns bleaching traces that only decrease over time.

### Example 5

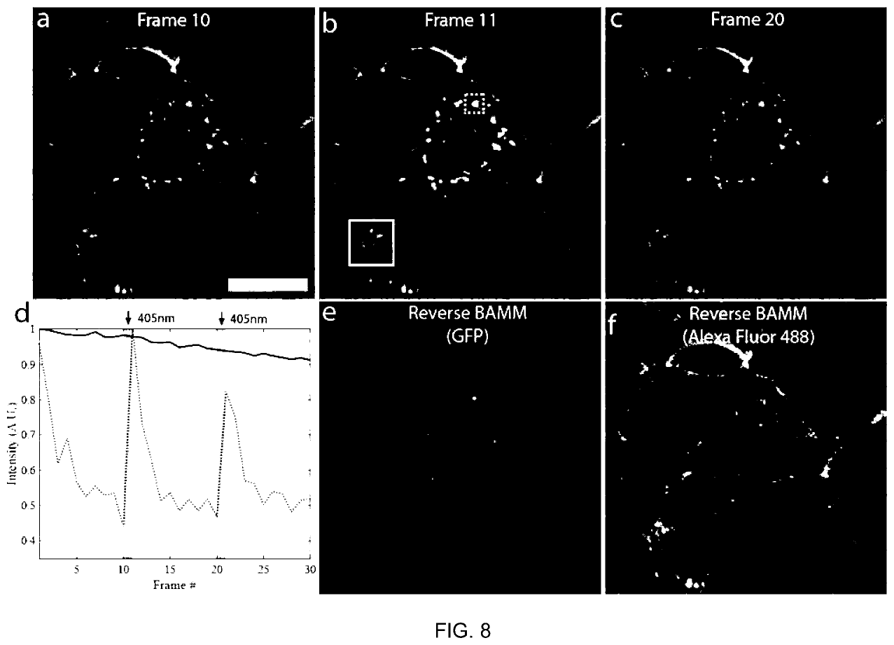

Referring now to FIGS. 8A to 8F, fluorophores, for example, fluorescent proteins or organic dyes such as those used to generate the time lapses, plots and abundance maps in FIGS. 8A to 8F, are known to undergo reversible photo bleaching and photoswitching. This is an inherent property of the fluorophore and is not to be confused with diffusion recovery processes used in techniques such as fluorescence recovery after photo bleaching (FRAP). Reversible photo bleaching provides additional ways of photochemical contrasting since fluorophores with different photo bleaching recovery behaviours can also be unmixed using the method described herein and referred to as BAMM. As a simple example GFP can be unmixed from Alexa Fluor 488 in fixed CaCO₂ cells by sequentially bleaching using 473 nm excitation and subsequently inducing photo bleaching recovery using a 405 nm beam. This procedure modulates the intensity of GFP, while Alexa Fluor 488 undergoes slight monotonic bleaching as shown in FIGS. 8A to 8D). The scale bar in these Figs. is 25 μm. Given the significant contrast, unmixed images can be obtained from pairs of bleached/recovered images (See FIGS. 8A and 8B, FIGS. 8E and 8F). In such a case, using the reversible photo bleaching properties as the distinguishing photostability characteristic of GFP significantly reduces the number of frames needed for unmixing.

The method of the present disclosure has been shown to work well with widefield and laser scanning confocal microscopes. An even illumination profile is critical for the present method since the photo bleaching rate is determined as a function of excitation intensity. Two fluorescent species located at different locations in the field-of-view may experience the same photo bleaching rate, if they are subject to different excitation intensities. This spatial variation in the photo bleaching rate has the potential to undermine the unmixing process.

If the illumination profile of the microscope is known a priori, the effect can be mitigated by adjusting the temporal binning at each pixel to compensate for the spatially dependent excitation dose. An alternative approach is to crop the field of view so that the illumination profile is uniform within a smaller region. Widefield illumination has the advantage that all fluorophores in a weakly absorbing 3D sample receive the same peak excitation dose. In a confocal microscope this is not the case as the excitation intensity is highest in the centre of the focal spot. Fluorophores above and below the focal plane accumulate the same total dose during image acquisition, but experience a smaller peak excitation power. If non-linear photo bleaching effects are large, this can cause a height dependent photo bleaching response. However, this effect is mitigated by the confocal aperture, which blocks most out-of-plane emission from reaching the detector.

In summary, the method of the present disclosure provides a novel microscopy method that employs photo bleaching as a contrast mechanism. Though photo bleaching is usually thought of as being detrimental to fluorescence microscopy, in accordance with the proposed method, this effect is exploited to extract more data from a sample. The method of the present disclosure makes use of a fundamentally different property of fluorophores (i.e. their photostability) than standard spectrally based fluorescence microscopy. As such, the method of the present disclosure can distinguish multiple fluorescent species using only a single emission channel, as well as separating spectrally identical fluorescent species. Using photo bleaching information according to some embodiments, it is possible to extract up to five fluorescent channels using only two spectral emission channels, to provide a 2.5× increase beyond what is possible using only spectral information. According to other embodiments. It is possible to extract up to three fluorescent channels using only a single spectral channel, to provide a 3× increase beyond what is possible using only spectral information.

Moreover, the use of more than two frames recorded in the time lapse recording decreases the signal to noise ratio delivering superior results to previously implemented methods. By recording more than two images during illumination of the sample with the light source to capture more data, more definitive results are obtained in which the user can have a higher degree of confidence.

Advantageously, the method of the present disclosure can be implemented using any digital fluorescence microscope, making it an attractive way to enhance the capabilities of existing microscopy suites.

The method of the present disclosure provides the distinctive advantage that it can separate spectrally identical fluorophores, provided they display variance in photostability under a designated or given set of imaging conditions.

Where the terms “comprise”, “comprises” “comprised” or “comprising” are used in this specification (including the claims), they are to be interpreted as specifying the presence of stated features, integers, steps or components referred to, but not preclude the presence of one or more other feature, integer, step, component or group thereof.

While the disclosure has been described in conjunction with a limited number of embodiments, it will be appreciated by those skilled in the art that many alternative, modifications and variations in light of the foregoing description are possible. Accordingly, the present disclosure is intended to embrace all such alternative, modifications and variations as may fall within the spirit and scope of the disclosure as disclosed.

The present application may be used as a basis or priority in respect of one or more future applications and the claims of any such future application may be directed to any one feature or combination of features that are described in the present application. Any such future application may include one or more of the following claims, which are given by way of example and are non-limiting in regard to what may be claimed in any future application.

The invention is claimed as follows:

1.-28. (canceled)

29. A method for distinguishing between more than one fluorescent species present in a sample in fluorescence microscopy, the method comprising:
(a) illuminating the sample with at least one light source;
(b) recording more than two images of the illuminated sample over a period of time, each image comprising a plurality of pixels, wherein each pixel corresponds to a location in the sample and records a degree of fluorescence at the location in the sample at a particular point in time; and
(c) determining a photostability characteristic of the degree of fluorescence at each pixel over the period of time over which the more than two images were recorded, wherein the photostability characteristic of the degree of fluorescence at each pixel is used to distinguish between the more than one fluorescent species present in the sample.

30. The method of claim 29, wherein using the photostability characteristic of the degree of fluorescence at each pixel to distinguish between the more than one fluorescent species present in the sample includes determining a photostability characteristic of the degree of fluorescence for each fluorescent species present in the sample, wherein the more than one fluorescent species present in the sample is at least three fluorescent species.

31. The method of claim 29, wherein using the photostability characteristic of the degree of fluorescence at each pixel to distinguish between the more than one fluorescent species present in the sample further includes determining an abundance of each fluorescent species present in the sample.

32. The method of claim 31, wherein the abundance of each fluorescent species present at each pixel over the period of time over which the more than two images were recorded is determined by applying an unmixing algorithm.

33. The method of claim 32, wherein the unmixing algorithm is one of: a singular value decomposition algorithm and a non-negative least squares algorithm.

34. The method of claim 29, wherein the photostability characteristic of the degree of fluorescence at each pixel over the period of time over which the more than two images were recorded is determined by applying an unmixing algorithm.

35. The method of claim 34, wherein the unmixing algorithm is one of: a non-negative matrix factorisation algorithm and a non-increasing non-negative matrix factorisation algorithm.

36. The method of claim 29, wherein the photostability characteristic relates to at least one: a decrease in photo intensity, and an increase in photo intensity.

37. The method of claim 29, wherein the sample is illuminated by more than one light source, each light source being configured to emit radiation at a particular wavelength.

38. The method of claim 29, further comprising:
(i) applying two or more spectral filters on one of: an emission side of the sample and an excitation side of the sample;
(ii) recording one image of the illuminated sample for each spectral filter, each image comprising a plurality of pixels, wherein each pixel corresponds to a location within the sample and records a degree of fluorescence at the location in the sample; and
(iii) determining a degree of fluorescence at each pixel within two or more spectral bands, each spectral band being associated with one of the spectral filters, wherein degree of fluorescence at each pixel within the two or more spectral bands is used to distinguish between the more than one fluorescent species present in the sample.

39. The method of claim 38, wherein each of the two or more spectral bands is associated with one of the two or more spectral filters.

40. The method of claim 38, wherein more than one light source is used to illuminate the sample and a single spectral filter is applied on one of the emission side of the sample and the excitation side of the sample, such that the two or more spectral bands are acquired by varying the light source.

41. A system configured to distinguish between more than one fluorescent species present in a sample in fluorescence microscopy, the system comprising:
at least one light source configured to illuminate the sample;
an image recording device configured to record more than two images of the illuminated sample over a period of time, each of the more than two images comprising a plurality of pixels, wherein each pixel corresponds to a location in the sample and records a degree of fluorescence at the location in the sample at a particular point in time;
a processor programmed to determine a photostability characteristic of the degree of fluorescence at each pixel over the period of time over which the more than two images were recorded; and
a display configured to present to a user the relative abundance of each fluorescent species in the sample at each pixel based on the photostability characteristic of the degree of fluorescence at each pixel.

42. The system of claim 41, wherein the processor is programmed to determine a photostability characteristic of the degree of fluorescence for each fluorescent species present in the sample prior to determining the photostability characteristic of the degree of fluorescence at each pixel over the period of time over which the more than two images were recorded as an indicator of the relative abundance of each fluorescent species in the sample at each pixel.

43. The system of claim 41, wherein the processor is programmed to apply an unmixing algorithm to determine the relative abundance of more than one fluorescent species at each pixel.

44. The system of claim 43, wherein the unmixing algorithm is one of: a singular value decomposition algorithm and a non-negative least squares algorithm.

45. The system of claim 41, wherein the processor is programmed to apply an unmixing algorithm to determine the photostability characteristic of the degree of fluorescence at each pixel over the period of time over which more than two images were recorded.

46. The system of claim 45, wherein the unmixing algorithm is one of: a non-negative matrix factorisation and a non-increasing non-negative matrix factorisation.

47. The system of claim 41, wherein the photostability characteristic relates to at least one of: a decrease in photo intensity and an increase in photo intensity.

48. A non-transitory computer readable medium comprising:
computer program code, which when executed by a processor, cause the processor to distinguish between more than one fluorescent species present in a sample in fluorescence microscopy by:
(a) causing the sample to be illuminated with at least one light source;
(b) recording more than two images of the illuminated sample over a period of time, each image comprising a plurality of pixels, wherein each pixel corresponds to a location in the sample and records a degree of fluorescence at the location in the sample at a particular point in time;
(c) determining a photostability characteristic of the degree of fluorescence at each pixel over the period of time over which the more than two images were recorded; and
(d) causing a display, by a display device, of a relative abundance map for each fluorescent species in the sample at each pixel based on the photostability characteristic of the degree of fluorescence at each pixel.
